(19) United States
(12) Patent Application Publication
(10) Pub. No.: US 2008/0170676 A1
(43) Pub. Date: Jul. 17, 2008

(54) Voice recognition advertisements

(75) Inventors: Peter J. Douma, Wyckoff, NJ (US); Karen S. Holm, Montvale, NJ (US)

Correspondence Address: RADER FISHMAN & GRAUER PLLC, LION BUILDING, 1233 20TH STREET N.W., SUITE 501, WASHINGTON, DC, 20036, US

(73) Assignees: Sony Corporation, Tokyo (JP); Sony Electronics Inc., Park Ridge, NJ (US)

(21) Appl. No.: 11/653,983

(22) Filed: Jan. 17, 2007

(51) Int. Cl. H04M 15/00

(52) U.S. Cl. 379/114.13

(57) ABSTRACT

Delivery of advertisements to participants in communications using a packetized telephony protocol (e.g., VoIP). This may comprise identifying a keyword used in a telephone conversation between parties, at least one of which uses a packetized telephony protocol device to participate in the telephone conversation. Then, a particular advertisement that includes image content is correlated to the telephone conversation based upon identification of the keyword. Delivery of the particular advertisement is prompted, preferably to the packetized telephony protocol device used by one or more of the parties to the telephone conversation. The delivery accommodates display of the image content for the particular advertisement without interrupting the telephone conversation between the parties.

### BACKGROUND OF THE INVENTION

1. Field of the Invention

This invention relates generally to voice communications and more particularly to delivery of advertisements associated with a voice communication.

2. Description of the Related Art

Traditional telephone communications are provided over a public switched telephone network (PSTN). The PSTN typically connects to caller locations via a connection to plain old telephone service (POTS) equipment, which includes wiring and telephones that couple to the PSTN interface. The PSTN is known as a circuit-switched network, essentially meaning that a call results in a circuit connection between callers to accommodate a telephone call.

Voice over Internet Protocol (VOIP) is an increasingly viable and preferable alternative to traditional circuit-switched telephony. With VOIP, voice is transmitted as packets of digital data over a network. VOIP is often marketed at relatively low flat rates that allow unlimited telephone calls. One problem with this is that some call recipients may be PSTN users. In these circumstances, PSTN line charges may accrue. If these charges accrue repeatedly, it may prompt additional charges that could be passed to the consumer.

It is known to allow exposure to advertisements to defray the costs of providing services. A notorious example is Internet access, but there are many examples, including the plethora of junk mail that is delivered through the US postal service. These schemes may be intrusive to the user of the system. That is, a person trying to access the Internet, or go through their mail, or make a VoIP telephone call may be bombarded with advertisements. The schemes are also often inefficient. That is, the same advertisement is delivered to multiple potential recipients, with the knowledge that only a few successful deliveries will suffice.

What is needed are techniques that allow for the delivery of advertisements in conjunction with packetized telephony protocol calls (such as VoIP) in a fashion that is more relevant and less intrusive.

### SUMMARY OF THE INVENTION

According to one aspect, the present invention provides for the delivery of advertisements to participants in communications using a packetized telephony protocol.

This may comprise identifying a keyword used in a telephone conversation between a first party and a second party, wherein at least the first party uses a packetized telephony protocol device to participate in the telephone conversation. Then, a particular advertisement that includes image content is correlated to the telephone conversation based upon identification of the keyword. Delivery of the particular advertisement is prompted, preferably to the packetized telephony protocol device used by one or more of the parties to the telephone conversation. The delivery accommodates display of the image content for the particular advertisement without interrupting the telephone conversation between the parties.

According to one embodiment, the packetized telephony protocol device is a VOIP telephone having a voice component used for voice communications and a display, wherein the image content for the advertisement is displayed on the display while the voice component is used for the telephone conversation.

According to another embodiment, the packetized telephony protocol device is a VOIP box that interfaces with a voice component used for voice communications and another device having a display.

According to another aspect, an accounting for delivery of advertisements including the particular advertisement based upon identification of keywords used in telephone conversations using the packetized telephony protocol is made. The accounted delivery of advertisements finances the supplemental usage of a public switched telephone network for telephone conversations using the packetized telephony protocol.

In addition to embodiments where a single keyword is used, the particular advertisement may be correlated to the telephone conversation based upon the identification of a combination of multiple keywords used in the telephone conversation, or in several telephone conversations. Various keywords, including but not limited to generic terms, specific terms, brand names, product names and the like may be used.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIG. 1A is a block diagram illustrating a packetized telephony protocol system and corresponding voice recognition advertisement system in accordance with the present invention.

FIG. 1B is a block diagram illustrating the voice recognition advertisement system provided in conjunction with the packetized telephony protocol system.

FIG. 1C is a block diagram illustrating the voice recognition advertisement system to further operate in conjunction systems including a portable telephone system.

FIG. 1D is a block diagram illustrating a packetized telephony protocol system that also implements a cable network system to provide PTP phone communication.

FIG. 1E is a block diagram illustrating a packetized telephony protocol system that also implements a personal computer to provide PTP phone communication.

FIGS. 2A-B are block diagrams illustrating a voice recognition advertising system that accommodates delivery of advertisements to participants in communications using a packetized telephony protocol.

FIG. 3 is a flow diagram illustrating a method of delivering advertisements to participants in communications using a packetized telephony protocol.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

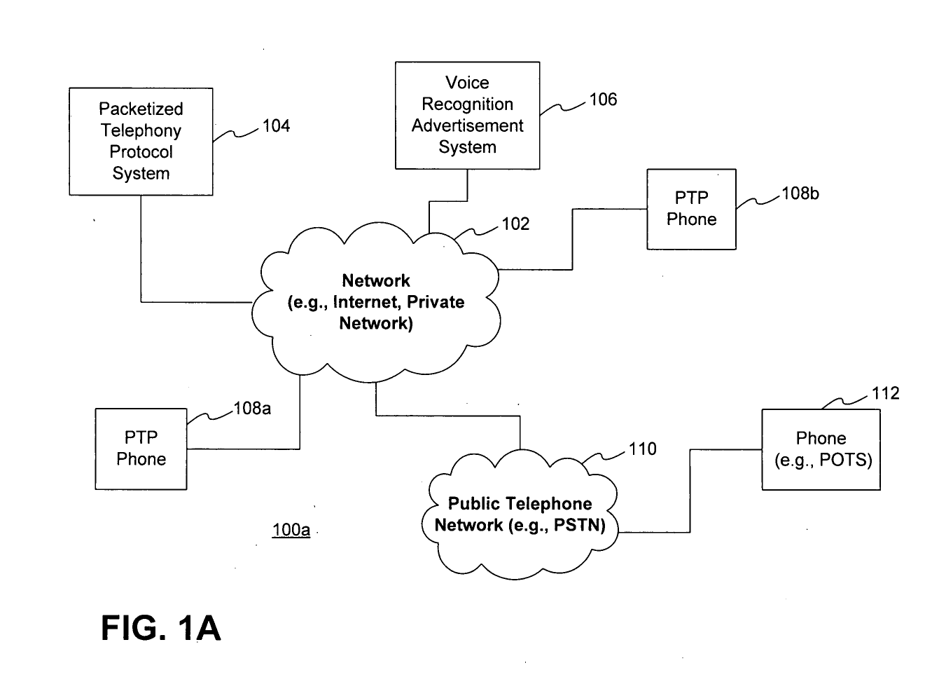

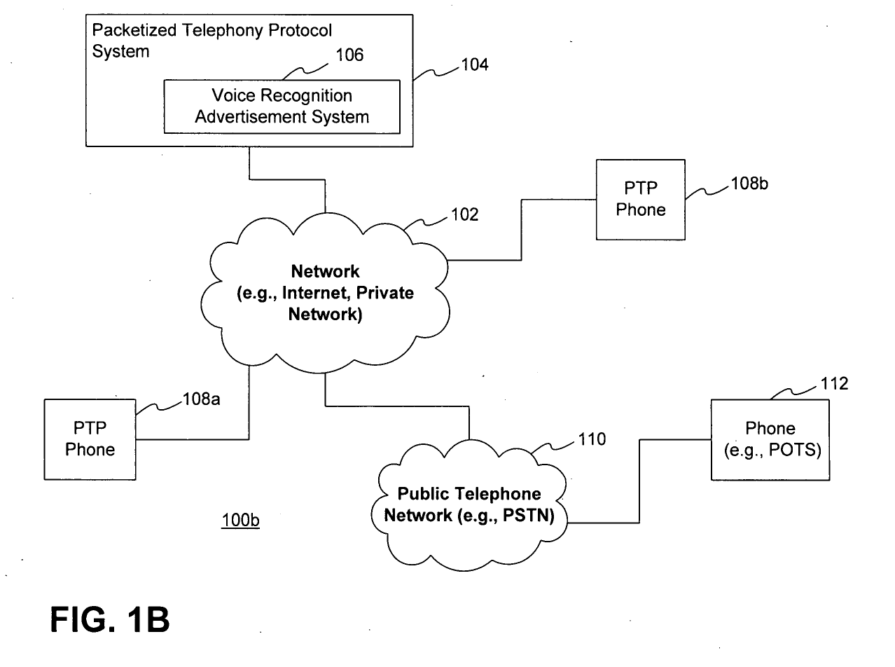

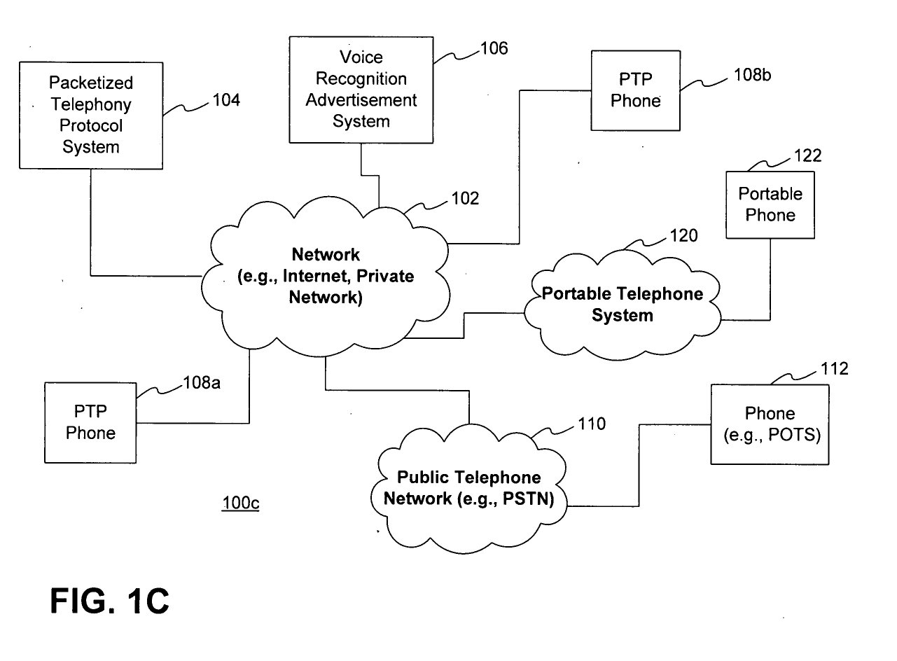

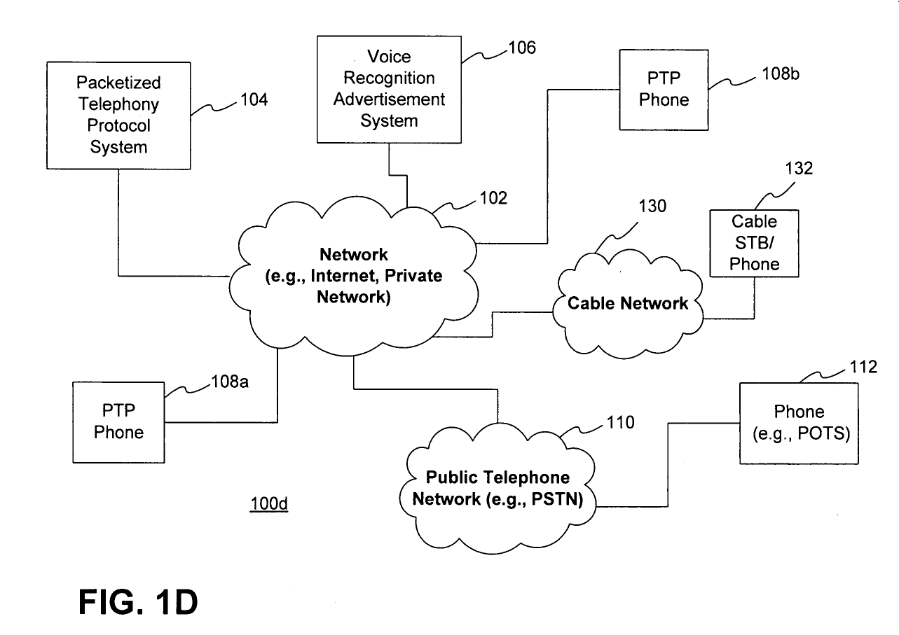

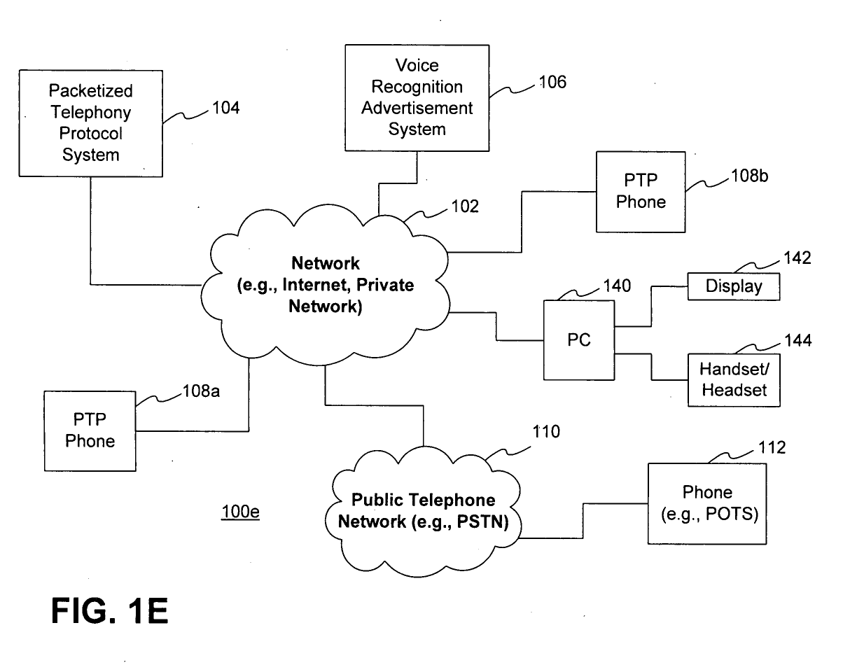

FIG. 1A is a block diagram illustrating a communications system 100a that includes a packetized telephony protocol system 104 and corresponding voice recognition advertisement system 106 in accordance with the present invention.

The packetized telephony protocol (PTP) system 104 allows telephone conversations including or between parties using PTP phones 108a, 108b over network 102.

An example of a PTP system 104 is a Voice over Internet Protocol (VoIP) system, which sends voice information digitally in discrete packets rather than the traditional approach of using a circuit connection such as is provided by the public switched telephone network (PSTN).

A variety of standards have been developed to facilitate the sending of voice and other information in conjunction with a VoIP system. For example, ITU-T H.323 is a standard for sending voice (audio) and video using IP on the Internet.

In addition to IP, VoIP may use the real-time protocol (RTP) to help ensure that packets get delivered in a timely way. Additionally, as indicated, the network may be a public network such as the Internet, or a private network. The private network currently offers a better opportunity to guarantee Quality of Service (QoS) for telephone calls. Regardless, the present invention may use any conventional PTP including but not limited to VoIP, and may use the described standards or others to send voice, video (which includes image), or other information.

To make calls with the PTP, one uses a PTP device of some kind (generically indicated as the PTP phones 108a-b in FIG. 1A). Two common examples are the use of dedicated PTP phones (e.g., VoIP phones) or an analog telephone adapter (ATA) which allows one to use traditional telephone equipment with a PTP system. The ATA may also be referred to as a VoIP box. The ATA connects to the standard telephone equipment and to a computer connected to the network (or directly to the network). The ATA provides analog to digital conversion, converting the analog signal of the phone to digital information to be transmitted over the network. When connected to the computer, the computer may provide a corresponding display. A dedicated PTP phone typically has a handset and keypad similar to a traditional phone, and also a display. The dedicated PTP phone also has a network interface and may connect directly to a network (e.g., through a router). Some PTP phones also include a wireless capability (e.g., Wi-Fi) that allows the interface to the network to be made wirelessly.

One useful feature of VoIP telephony is that it avoids the tolls charged by ordinary telephone service. However, where a telephone call is made to another party that requires some usage of the PSTN 110, such charges may still be present. For example, although a caller may use a PTP phone such as a VoIP telephone to make a telephone call, the person that they are calling may still be use the PSTN 110 for calls, using plain old telephone service (POTS) equipment. In these and potentially other multi-network circumstances, there may be a need to accommodate the existence of such potential charges.

The communications system 100a also includes a voice recognition system 106. According to one aspect of the present invention, the voice recognition system 106 delivers advertisements to participants in telephone calls using the PTP system 104, with efficient determination of the propriety of the advertisement based upon recognition of words that are used by the participants in the telephone call. Moreover, these advertisements include image content (e.g., a still image, or video) that is delivered to the location of at least one of the call participants without interrupting the telephone conversation between the parties. This allows the advertiser to enjoy the benefit of potentially making the consumer aware of the advertisement at or near a time when the advertisement is deemed relevant and appropriate to the consumer. It also accomplishes this without being unduly intrusive to the user, particularly since the voice portion of the call is not interrupted by the delivery of the advertisement. As described further below, a variety of techniques may be implemented to correlate potential advertisements to caller(s), including those that correlate respective keywords to advertisements, as well as combinations of keywords.

According to another aspect, providing advertisements that are particularly tied to the context of the telephone conversation is believed to be of enhanced value. The delivery of advertisements accounted for and reported according to the present invention. Examples of accounting include recording times delivered, as well as tracking whether an advertisement is invoked by the recipient. According to this aspect, the consideration corresponding to the delivery of advertisements compensates for the charges required by a second network (i.e., one other than the PTP system network), most notably PSTN line charges.

FIG. 1A illustrates the voice recognition advertising system 106 as a separate entity from the PTP system 104. In that regard, the voice recognition advertising system 106 may have a role of an application service provider. The system 106 communicates with the PTP system 104 and corresponding call participants using conventional network communication protocols. FIG. 1B illustrates that voice recognition advertising system 106 being provided within the context of the PTP system 104. That is, as part of the bundle of services provided under the direction and control of the PTP system 104 providers. It should be understood that the voice recognition advertising system 106 can be variously provided and controlled by interested parties.

There are other ways to implement PTP system 104 based calls, and other networks (in addition to PSTN 110) may also operate in conjunction with the PTP system 104. For example, FIG. 1C illustrates the voice recognition advertisement system 106 to further operate in conjunction systems including a portable (e.g., cellular) telephone system 120. Conventional techniques may be used to appropriately route calls made via the PTP system 104 through the networks used by the call recipient, including but not limited to the cellular network. Additionally, it should be noted that users may implement hybrid devices that are capable of using multiple different networks. For example, a handheld device may be configured to accommodate front end interfacing with the PTP system 104, a cellular network, or a WiFi network. These devices (including regular cellular phones) are often equipped with displays that accommodate the display of advertisements in connection with certain aspects of the present invention.

As another example, the robust processing capabilities of the personal computer may be implemented to variously engage in communications. FIG. 1E illustrates a system 100e wherein the PTP system 104 may work in conjunction with a user operating a PC 140 configured to include voice capability. This may typically be provided through a microphone and speaker or a headset 144 having both functions. The PC 140 may be variously connected to a network 102 through any number of connections (e.g., through a LAN, directly through a cable modem/router, etc.). As such, the PC 140 is readily configurable for packetized communication including but not limited to that implemented by the PTP system 104. The PC 140 is also configured to include a display 144 capability, useful in connection with various aspects of the embodiments of invention described herein.

There are still other ways to implement PTP system 104 based calls. FIG. 1D is a block diagram illustrating a PTP system 104 operating in conjunction with a cable network 130 that allows communication using a set top box (STB) 132. The STB 132 may also connect to a PTP phone or related equipment as described above. For example, the cable network 130 may provide PTP (e.g., VoIP) telephony services for subscribes via the cable lines and STB 132. In this circumstance, certain callers may use cable service providers as a source of telephony services instead of the traditional telephone companies, with the services being provided through the cable from the headend of the cable network 130. The cable network 130 may also be coupled to the Internet 102 and the PSTN 110 via gateways to route calls to and from subscribers. The STB 132 may also receive and differentiate between packetized voice calls and cable television signaling, and receive typical commands from a subscriber using a remote control.

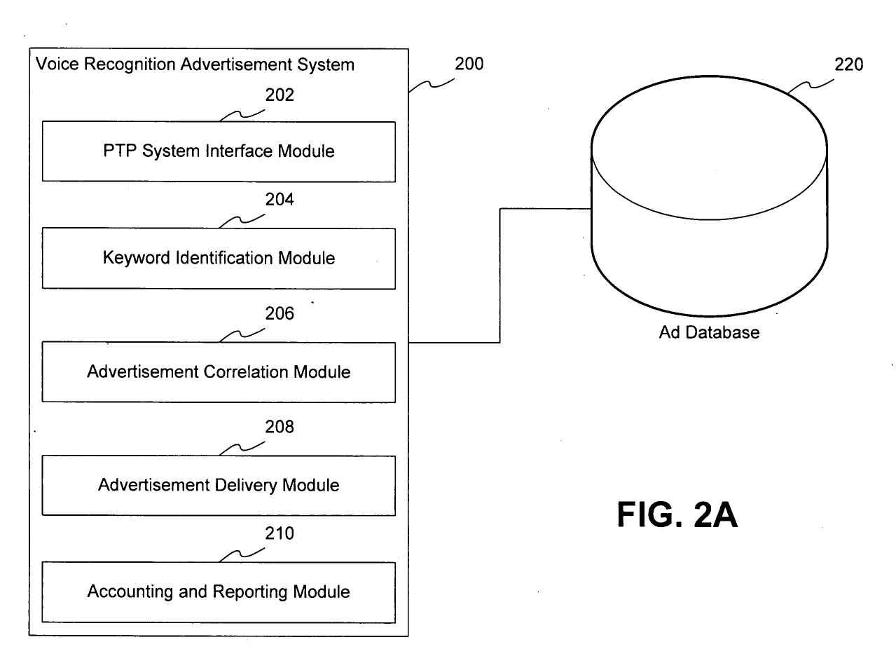

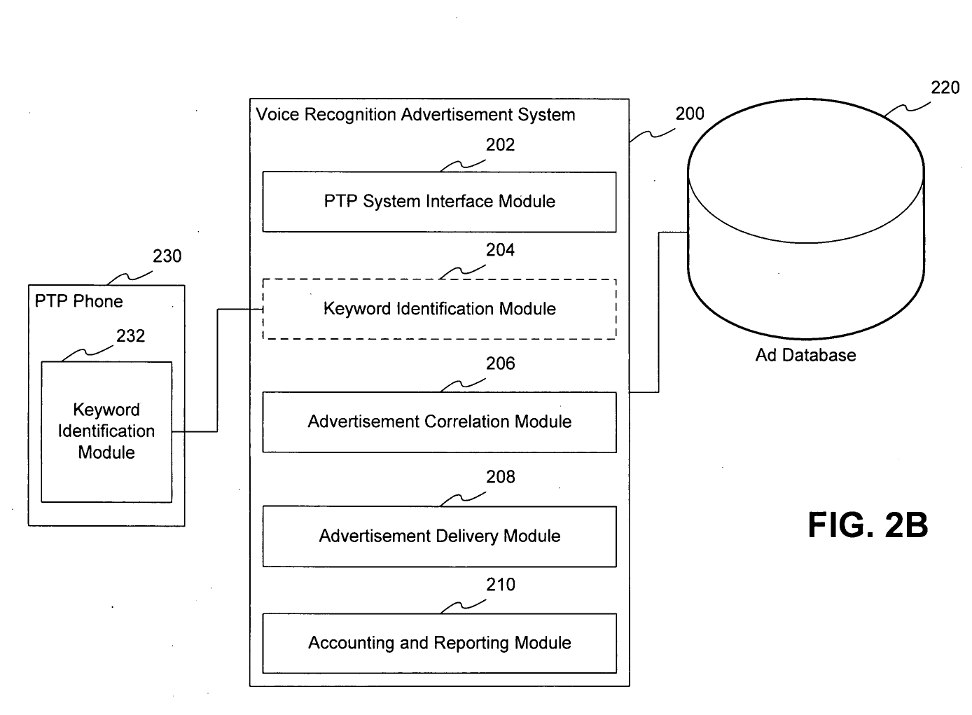

FIGS. 2A-B are block diagrams illustrating a voice recognition advertising system 200 that accommodates delivery of advertisements to participants in communications using a packetized telephony protocol. The voice recognition advertising system 200 may be variously implemented. For example, it may be provided by a server configured to include conventional processing resources to carry out the functionality described herein. It may also be provided as software that is stored on a computer readable medium including but not limited to optical discs, hard drives, and the like. It may also be resident in memory on a computer system. The voice recognition advertising system 200 is preferably software based, but may also implement hardware or firmware. Additionally, although one modular breakdown of the functionality is illustrated and described herein, it should be understood that the functionality may be provided by fewer, more or differently named modules.

The voice recognition advertising system 200 includes a PTP system interface module 202, a keyword identification module 204, an advertisement correlation module 206, an advertisement delivery module 208, and an accounting and reporting module 210. The system 200 also operates in conjunction with an advertisement database 220, which stores advertisements that are prompted for delivery to callers in conjunction with certain embodiments of the present invention.

The PTP system interface module 202 is allows the voice recognition advertising system 200 to interface with the PTP system. This allows for the receipt of information (including but not necessarily limited to words used in telephone calls) as well as the delivery of advertisements to callers. In one example, as described previously, advertisements are delivered to PTP system call participants under the same bundle or umbrella of services. In this circumstance, the voice recognition advertisement system 200 is integrated with the provided telephony services. In other examples, the information may be provided to the voice recognition advertisement system 200 by the PTP system components, such as through a network connection. Additionally, information may be provided to the voice recognition advertisement system 200 at the direction of software located at the client-caller side.

Preferably, advertisements are delivered to at least one participant in a telephone conversation while the conversation is occurring, but are delivered without interrupting that telephone conversation. In conjunction with that, the advertisements are correlated to the telephone conversation by detecting keywords used in the conversation. The identification of keywords and correlation of advertisements are respectively provided by the keyword identification module 204 and the advertisement correlation module 206.

There are various ways for the keyword identification module 204 to identify keywords that are used in the telephone conversation. In one example, the keyword identification module 204 has access to the content of the telephone conversation, and compares the content of the telephone conversation to a stored library of keywords to determine whether there are any matches. The keyword identification module 204 may examine the content in the digital domain (or, alternatively, in the analog domain) and implement voice recognition software to identify whether any keywords exist in the recognized content. For example, the voice recognition software voice-to-text converts portions (or all) of the telephone conversation, and then lexical stream parsing and related techniques are used to identify the existence of keywords used in the conversation.

In one example, which for some applications may be preferred from a processing resource distribution perspective, the conversion and parsing of the telephone call content may occur at the location of the caller. Indeed, it should be noted, the entire voice recognition advertisement system functionality may be provided at the caller location.

The same principle may of course apply to all of the alternative systems previously described. That is, a PC, cellular phone, cable STB or the like may be similarly configured.

As illustrated in FIG. 2B, the PTP phone 230 is configured to include the keyword identification module 232 to provide such a functionality. It is also noted that a division of tasks may be implemented as between the keyword identification module 104 present in the PTP phone 230 and that present in the voice recognition advertisement system 200. That is, the interception, parsing and identification of keywords may be performed at the caller location (e.g., PTP phone 230), but the library of keywords may be managed at a different location where the remaining voice recognition advertisement system 200 functions are performed. This allows a centralized management of the keyword library, possibly in conjunction with information about the corresponding library of available advertisements, but a de-centralization of the processing resources required to carry out the parsing of conversations to identify keywords. The library of keywords may be variously updated, such as by pushing an updated list to the PTP phone 230 on a periodic basis.

It should also be noted that the keyword identification module 104 located at the caller-side may parse and identify several keywords, and then send them to the remainder of the voice recognition advertisement system 200 resident at another location, for processing the list of detected keywords. Thus, the most relevant keyword(s) from a larger pool of detected keywords may be identified.

The advertisement correlation module 206 correlates advertisements to the telephone conversation based upon the identified keywords, preferably advertisements that include image content (e.g., still images, video, etc.). The advertisement correlation module 206 performs this task in conjunction with the keywords that are detected and/or received by the keyword identification module 204.

The advertisement correlation module 206 is variously configured to deliver levels of complexity with regard to the identification of advertisements. The advertisement correlation module 206 stores a table correlating keywords to advertisements, and may receive updates in that regard.

In a simple example, the first keyword that has an entry in the table is correlated to a related advertisement, and that advertisement is selected. For example, “car” may be a keyword found in the table, correlated to a particular automobile advertisement. When it is determined that the keyword “car” is used in the telephone conversation, that particular automobile advertisement is correlated to the call.

In another example, keyword combinations are detected and applied to find correlated advertisements. For example, if the terms “new” and “car” are used, then an advertisement typically associated with a new car purchase may be selected. Proximity between terms may also be used to help ensure that the correlation is accurate. That is, if the terms “new” and “car” are used, but at vastly different points in time, it may be presumed that the terms were not associated. Various logic may be provided in this regard.

Additionally, the correlation of advertisements based upon multiple keywords may be spread across several telephone calls. That is, the keywords used in calls are retained in memory for a given period of time. The retention and usage of such keywords may be referred to as a history mode of operation.

Moreover, the context of keyword usage may be examined. For example, if the telephone call is with a party fitting a particular profile, then the listing of keywords corresponding to the telephone call may be tailored accordingly. For example, a discussion with a friend about places to eat might prompt provision of a keyword listing that is different from the keyword listing that is used when the discussion is made in a business context.

In addition to generic terms, particular terms and brand names may also be detected and correlated to advertisements. Thus, an advertisement for a product or service corresponding to the spoken brand name (or a competitor's) may be correlated to the telephone conversation.

The advertisement delivery module 208 communicates with the advertisement correlation module 206 and receives an indication of the identified advertisement. The advertisement is then delivered to at least one of the call participants. As described, the advertisement preferably includes image content, and this image content is preferably displayed without interrupting the telephone conversation involving the parties. For example, the advertisement may appear on the display screen of the PTP system phone that is being used for the telephone call (even if a portion of the display is also being used for video between the calling parties). An alternative calling device having a display such as a PC, cable STB or cellular phone may also receive the advertisement without interrupting the call in this fashion. The advertisements may be delivered through the receiving devices application making the call, through the device's browser or RSS feed reader, or simply emailed.

The accounting and reporting module 210 communicates with the advertisement delivery module 208 and receives indications that advertisements have been prompted for delivery. The accounting and reporting module 210 thus retains a record of the advertisements that have been delivered, and prepares reports corresponding to such. According to another aspect of this invention, consideration corresponding to the delivery of advertisements finances incidental costs of using the PTP system, including PSTN line charges for telephone calls involving parties that use such lines.

In addition to prompting the delivery of advertisements and display of the image content as noted, facilities for marking and storing advertisements for subsequent review or corresponding action are provided. For example, the call participant sees the image content for an advertisement, and marks the advertisement for storage and review following completion of the telephone call. This marking may be performed by using an object to mark a location on the image display, pressing a key (e.g., “enter”, or any key) indicating a desire to mark the advertisement, or the like.

Means are also provided for initiating a call in relation to the advertisement, or a link to a web site, in conjunction with the subsequent display of the advertisement. Thus, for example, the caller may initiate a PTP system based call to a car dealer where the advertisement was for a particular car. This may be performed by providing information associated with the delivered advertisement, and offering the recipient an opportunity to automatically initiate a PTP system call to the third party associated with the advertisement. For example, a supplemental display area may indicate the opportunity to “call now”, which may be variously actuated by keystroke, cursor or related operations. Alternatively, the advertisement may contain an embedded link to a website offering additional information about the corresponding product. These functions are provided using conventional techniques, including but not limited to embedded links and metadata associated with the delivery of the initial advertisement. Moreover, implementation of any of these additional functions may be accounted and reported as noted above.

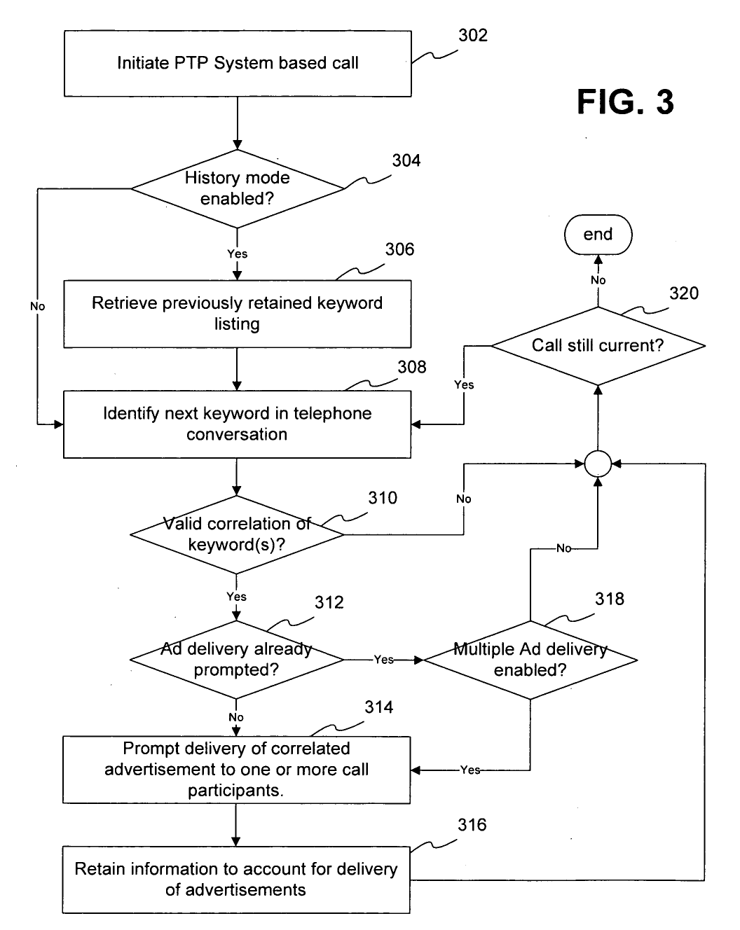

FIG. 3 is a flow diagram illustrating a method 300 of delivering advertisements to participants in communications using a packetized telephony protocol.

A caller initiates 302 a PTP system based call, which can be performed in conventional fashion, by calling another party and having that party answer that call. Of course, call involving more than two parties may also be provided.

If the history mode is enabled, then previously detected keywords are used in the process. Accordingly, if it is determined 304 that the history mode is enabled, then the previously retained keyword listing is retrieved 306.

The next keyword in the telephone conversation is then identified 308. As described, this may be performed by converting the conversation to text and parsing the stream. The detected words are compared to the keyword listing, to determine whether any correlated advertisements are available. If a valid correlation to a keyword is found 310, a check 312 is made to see whether an advertisement has already been delivered. If so, another check 318 determines whether multiple advertisement delivery is enabled. If such is not the case, then the process of detecting keywords continues but the ad is not delivered, at least during the course of the conversation. The usage of the keyword is retained for future reference.

However, if an ad has not been delivered, or if multiple advertisement delivery is enabled, then the system prompts 314 delivery of the correlated advertisement to one or more call participants. The information about the delivery of the advertisement is retained 316 to account for the same. It should be noted that the delivery of the advertisement is not necessarily the only act that may be accounted for. Additional actions including those by the advertisement recipients may also be tracked and monitored. For example, additional revenue may accrue where the recipient clicks through a provided ad, or makes an actual purchase corresponding to the ad, or forwards that ad, and so on.

Thus embodiments of the present invention produce and provide for the delivery of advertisements to participants in telephone calls. Although the present invention has been described in considerable detail with reference to certain embodiments thereof, the invention may be variously embodied without departing from the spirit or scope of the invention. Therefore, the following claims should not be limited to the description of the embodiments contained herein in any way.

1. A method for delivering advertisements to participants in communications using a packetized telephony protocol, the method comprising:
identifying a keyword used in a telephone conversation between a first party and a second party that uses the packetized telephony protocol, wherein at least the first party uses a packetized telephony protocol device to participate in the telephone conversation;
correlating a particular advertisement that includes image content to the telephone conversation based upon identification of the keyword; and
prompting the delivery of the particular advertisement to the packetized telephony protocol device used by the first party during the telephone conversation, wherein the delivery of the particular advertisement accommodates display of the image content for the particular advertisement without interrupting the telephone conversation between the first party and the second party.

2. The method of claim 1, wherein the packetized telephony protocol device is a VOIP telephone having a voice component used for voice communications and a display, and wherein the image content for the particular advertisement is displayed on the display while the voice component is used for the telephone conversation.

3. The method of claim 1, wherein the packetized telephony protocol device is a VOIP box that interfaces with a voice component used for voice communications and another device having a display.

4. The method of claim 1, further comprising:
accounting for delivery of advertisements including the particular advertisement based upon identification of keywords used in telephone conversations using the packetized telephony protocol; and
reporting the accounted delivery of advertisement, wherein the accounted delivery of advertisements finances the supplemental usage of a public switched telephone network for telephone conversations using the packetized telephony protocol.

5. The method of claim 1, wherein the packetized telephony protocol is VOIP.

6. The method of claim 1, wherein the particular advertisement is correlated to the telephone conversation based upon the identification of a combination of multiple keywords used in the telephone conversation.

7. The method of claim 1, wherein the particular advertisement is correlated to the telephone conversation based upon the identification of a combination of multiple keywords respectively used in the telephone conversation and previous telephone conversations.

8. The method of claim 1, wherein the keyword is a brand name and the particular advertisement is for a product or service marketed under the brand name.

9. The method of claim 1, wherein the voice component comprises a handset or a headset.

10. The method of claim 1, further comprising:
accommodating an automatically initiated packetized telephony protocol telephone call to a third party associated with the particular advertisement following the conclusion of the telephone conversation between the first party and the second party based upon a selection made by the first party in association with the display of the particular advertisement.

11. A system for delivering advertisements to participants in communications using a packetized telephony protocol, the system comprising:
means for identifying a keyword used in a telephone conversation between a first party and a second party that uses the packetized telephony protocol, wherein at least the first party uses a packetized telephony protocol device to participate in the telephone conversation;
means for correlating a particular advertisement that includes image content to the telephone conversation based upon identification of the keyword; and
means for prompting the delivery of the particular advertisement to the packetized telephony protocol device used by the first party during the telephone conversation, wherein the delivery of the particular advertisement accommodates display of the image content for the particular advertisement without interrupting the telephone conversation between the first party and the second party.

12. The system of claim 11, wherein the packetized telephony protocol device is a VOIP telephone having a voice component used for voice communications and a display, and wherein the image content for the particular advertisement is displayed on the display while the voice component is used for the telephone conversation.

13. The system of claim 11, further comprising:
means for accounting for delivery of advertisements including the particular advertisement based upon identification of keywords used in telephone conversations using the packetized telephony protocol; and
means for reporting the accounted delivery of advertisement, wherein the accounted delivery of advertisements finances the supplemental usage of a public switched telephone network for telephone conversations using the packetized telephony protocol.

14. The system of claim 1 wherein the particular advertisement is correlated to the telephone conversation based upon the identification of a combination of multiple keywords used in the telephone conversation.

15. The system of claim 11, wherein the particular advertisement is correlated to the telephone conversation based upon the identification of a combination of multiple keywords respectively used in the telephone conversation and previous telephone conversations.

16. The system of claim 11, further comprising:
means for accommodating an automatically initiated packetized telephony protocol telephone call to a third party associated with the particular advertisement following the conclusion of the telephone conversation between the first party and the second party based upon a selection made by the first party in association with the display of the particular advertisement.

17. An apparatus for delivering advertisements to participants in communications using a packetized telephony protocol, the apparatus comprising:
a keyword identification module, which identifies a keyword used in a telephone conversation between a first party and a second party that uses the packetized telephony protocol, wherein at least the first party uses a packetized telephony protocol device to participate in the telephone conversation;
an advertisement correlation module, in communication with the keyword identification module, which correlates a particular advertisement that includes image content to the telephone conversation based upon identification of the keyword; and
an advertisement delivery module, in communication with the advertisement correlation module, which prompts the delivery of the particular advertisement to the packetized telephony protocol device used by the first party during the telephone conversation, wherein the delivery of the particular advertisement accommodates display of the image content for the particular advertisement without interrupting the telephone conversation between the first party and the second party.

18. The apparatus of claim 17, wherein the packetized telephony protocol device is a VOIP telephone having a voice component used for voice communications and a display, and wherein the image content for the particular advertisement is displayed on the display while the voice component is used for the telephone conversation.

19. The apparatus of claim 17, further comprising:
an accounting and reporting module, which accounts for delivery of advertisements including the particular advertisement based upon identification of keywords used in telephone conversations using the packetized telephony protocol, and reports the accounted delivery of advertisements, wherein the accounted delivery of advertisements finances the supplemental usage of a public switched telephone network for telephone conversations using the packetized telephony protocol.

20. The apparatus of claim 17, wherein an automatically initiated packetized telephony protocol telephone call to a third party associated with the particular advertisement is accommodated, following the conclusion of the telephone conversation between the first party and the second party based upon a selection made by the first party in association with the display of the particular advertisement.
